(19) United States
(12) Patent Application Publication
(10) Pub. No.: US 2006/0251079 A1
(43) Pub. Date: Nov. 9, 2006

(54) Method and apparatus for transmitting packet data

(76) Inventors: No-Jun Kwak, Seoul (KR); Gert Jan Van Lieshout, Middlesex (GB); Kook-Heui Lee, Yongin-si (KR); Soeng-Hun Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/386,108

(22) Filed: Mar. 22, 2006

(30) Foreign Application Priority Data
Mar. 22, 2005 (KR) 2005-23728
Mar. 26, 2005 (KR) 2005-25270

(51) Int. Cl. H04L 12/56

(52) U.S. Cl. 370/394

(57) ABSTRACT

A method and apparatus are provided for transmitting packet data over an uplink channel in a mobile communication system in which retransmission of a packet is possible using a hybrid automatic retransmission request (HARQ) technique. A base station receives a packet data unit (PDU) from a terminal and determines whether the base station can calculate a retransmission number (RSN) indicating the number of retransmissions for the PDU. If the base station cannot calculate the RSN for the PDU, the base station sets the RSN to a special value indicating that the number of retransmissions for the PDU is unknown, and transmits the set RSN to a serving radio network controller (SRNC) along with the PDU.

### PRIORITY

This application claims the benefit under 35 U.S.C. § 119(a) of an application entitled “Method and Apparatus for Transmitting Packet Data”, filed in the Korean Intellectual Property Office on Mar. 22, 2005 and assigned Serial No. 2005-23728, and an application entitled “Method and Apparatus for Transmitting Packet Data”, filed in the Korean Intellectual Property Office on Mar. 26, 2005 and assigned Serial No. 2005-25270, the entire disclosures of which are hereby incorporated by reference.

### BACKGROUND OF THE INVENTION

1. Field of the Invention

The present invention relates generally to a mobile communication system for transmitting packet data over an uplink. More particularly, the present invention relates to a method and apparatus in which a base station (or Node B) reports a situation to a Serving Radio Network Controller (SRNC) when it cannot calculate a correct retransmission number in the situation where it can retransmit the same packet using a Hybrid Automatic Retransmission Request (HARQ) technique.

2. Description of the Related Art

An Enhanced Uplink Dedicated Channel (EUDCH) is used in an asynchronous Wideband Code Division Multiple Access (WCDMA) communication system. The EUDCH was proposed to improve the performance of uplink packet transmission in asynchronous WCDMA communication systems.

A mobile communication system supporting the EUDCH maximizes efficiency of uplink transmission using a fast scheduling technique and a Hybrid Automatic Retransmission Request (HARQ) technique. In the fast scheduling technique, a Node B receives a report on channel conditions and buffer conditions of user equipments (UEs). The Node B controls uplink transmission of the UEs based on the received information. The Node B allows UEs with good channel conditions to transmit the maximum amount of data, and allows UEs with bad channel conditions to transmit the minimum volume of data, thereby facilitating efficient use of the limited uplink transmission resources. The HARQ technique retransmits a packet in order to compensate for a packet error when the error occurs in the packet at initial transmission. The HARQ technique can be divided into a Chase Combining (CC) technique and an Incremental Redundancy (IR) technique. The CC technique retransmits packets in the same format as that used for initial transmission when an error occurs. The IR technique retransmits packets in a format different from that used for initial transmission when an error occurs.

The EUDCH performs HARQ between the UEs and the Node B, thereby increasing a ratio of successful transmission to transmission output. The HARQ technique soft-combines a defective data block with its retransmitted data block instead of discarding the defective data block, thereby increasing a reception success rate of the data block.

FIG. 1A is a diagram illustrating a protocol structure of a general mobile communication system supporting the EUDCH.

Referring to FIG. 1A, a UE 105 includes a physical (PHY) layer 125, a MAC-e layer 120, a MAC-d layer 115, and an upper layer 110. The upper layer 110 includes an application in which the user data is actually generated, and a Radio Link Control (RLC) layer for reconfiguring the user data into a size suitable for radio channel transmission. The MAC-d layer 115 inserts multiplexing information into the data provided from the upper layer 110 to generate a MAC-d Protocol Data Unit (PDU).

The MAC-e layer 120 stores MAC-d PDUs provided from the MAC-d layer 115 in a priority queue (PQ) according to their priorities. Further, the MAC-e layer 120 transmits a buffer status report and a channel quality report to a Node B 130 taking a state of the PQ into account. Thereafter, the MAC-e 120 receives scheduling information from the Node B 130, and delivers the data stored in the PQ to the physical layer 125 according to the scheduling information. In this case, the MAC-e layer 120 performs an HARQ operation on the uplink data delivered to the physical layer 125 taking into account a response signal (an Acknowledgement (ACK) signal and a Negative Acknowledgement (NACK) signal) received from the Node B 130.

The physical layer 125 transmits the data provided from the MAC-e layer 120 to the Node B 130 over a radio channel after processing.

The Node B 130 includes a MAC-e layer 135 and a physical layer 140. The Node B 130 further includes Layer 2 (L2) and Layer 1 (L1) 145 for transmitting packet data to a Radio Network Controller (RNC) 150. The physical layer 140 serves to process a signal provided via the physical layer 125 of the UE 105 and delivers the processed signal to the MAC-e layer 135.

The MAC-e layer 135 conveys the data provided from the physical layer 140 to the L2/L1 145 and performs scheduling on a plurality of UEs based on the buffer status report and the channel quality report transmitted by the UE 105. Herein, the data transmitted by the UE 105 for one HARQ process is called a MAC-e PDU. The Node B 130 can transmit the MAC-e PDUs received from the UE 105 to the RNC 150 for several Transmit Time Intervals (TTIs). Several logical channels can be mapped to one MAC-e PDU, and a set of the logical channel PDUs included in one MAC-e PDU is called a MAC-es PDU.

The RNC 150 includes an upper layer 170, a MAC-d layer 165, a MAC-e layer 160, and an L2/L1 155 for receiving the data transmitted by the Node B 130.

The MAC-e layer 160 included in the RNC 150 additionally implements separate functions that can be hardly implemented in the MAC-e layer 135 of the Node B 130. For example, the MAC-e layer 160 can classify the packet data transmitted by a plurality of UEs including the UE 105 according to a PQ, and reorder the classified data in the PQ.

As described above, the UE 105 includes the PQ and stores the data to be transmitted over the EUDCH in the PQ according to priority. The PQ is created in the MAC-e layer 120 of the UE 105 when a EUDCH call is set up, and the number of PQs is determined in accordance with the number of applications to be serviced through the EUDCH.

Therefore, in making the buffer status report, the UE 105 provides the Node B 130 with information indicating the total amount of data stored in each individual PQ. Based on the provided information, the Node B 130 performs scheduling taking into account channel conditions of the UEs and priority of the data stored in the PQ.

FIG. 1B is a diagram illustrating a structure of a MAC layer for a general UE and a format of one MAC-e PDU.

Referring to FIG. 1B, the data transmitted by a UE for one HARQ process is called a MAC-e PDU 130-1. Several logical channels can be mapped to one MAC-e PDU, and a set of logical channel PDUs included in one MAC-e PDU is called a MAC-es PDU 120-1.

An RLC PDU 100-1 corresponding to one logical channel is mapped to a MAC-d PDU 110-1. A MAC-e header has a 6-bit Data Description Indicator (DDI) 131-1 to indicate a logical channel, a MAC-d flow, and a MAC-d PDU size. An N field 135-1 indicates the number of consecutive MAC-d PDUs corresponding to the DDI. A 6-bit Transmit Sequence Number (TSN) 125-1 exists in every logical channel, and increases by one each time the MAC-e PDU is transmitted. Thus, the TSN 125-1 is used for packet reordering in a Serving RNC (SRNC).

FIG. 2 is a diagram illustrating a MAC-e configuration and an HARQ operation of a general UE.

Referring to FIG. 2, a MAC-e layer of a UE includes priority queues (PQs) 205 and an HARQ entity 210.

The PQs 205 are buffers for storing data provided from an upper layer according to priority, before transmission. A UE can include a plurality of PQs. One PQ stores data having the same priority. The priority is commonly allocated for each individual logical channel. The logical channel is created between an RLC layer and a MAC layer, and in many cases, an arbitrary user application is mapped to one logical channel. Therefore, one PQ is connected to one logical channel, or can be connected to a plurality of logical channels having the same priority.

The HARQ entity 210 controls operations of HARQ processors. That is, the HARQ entity 210 can take charge of determining initial transmission or retransmission through analysis of an ACK/NACK signal, and can control transmission/reception of each HARQ processor.

HARQ processors 215, 225, 230 and 235 each include a soft buffer 220, and are devices for taking charge of an HARQ operation in a radio channel. The term “HARQ operation” refers to a technique for performing retransmission and soft combining on the data processed in the physical layer, thereby maximizing retransmission gain.

The HARQ processors 215, 225, 230 and 235 of a transmission part transmit data to reception HARQ processors 240, 245, 250 and 255 and store the previously transmitted data in their soft buffers.

Each of the reception HARQ processors 240, 245, 250 and 255 determine whether there is an error in the received data. If there is no error in the received data, the corresponding reception HARQ processor transmits an ACK signal, and the associated transmission HARQ processor discards the data stored in its soft buffer. However, if there is any error in the received data, the corresponding reception HARQ processor transmits a NACK signal. The NACK signal allows the associated transmission HARQ processor to retransmit the data stored in its soft buffer, and then the reception HARQ processor soft—combines the retransmitted data with the data stored in its soft buffer to maximize the retransmission gain.

To facilitate implementation of the HARQ, a UE transmits a ‘Retransmission Number (RSN)’ indicating the number of retransmissions for the currently transmitted MAC-e PDU over an Enhanced-Dedicated Physical Control Channel (E-DPCCH) which is a control channel. The RSN is set with 2 bits to maximize efficiency of a radio section, and is set to ‘0’ for a first transmission, ‘1’ for a second transmission, ‘2’ for a third transmission, and ‘3’ for all third or later retransmissions, such as, fourth or later transmissions. However, in a wire section from a Node B to an RNC, the RSN is set with 4 bits and transmitted in a user plane along with a MAC-es PDU.

Herein, the 2-bit RSN transmitted in the radio section (Uu interface) will be referred to as an “R-RSN,” and the 4-bit RSN transmitted in the wire section (lub/lur interface) will be referred to as an “N-RSN.”

FIG. 3 is a diagram illustrating an exemplary 2 ms-TTI MAC frame transmitted from a Node B to an RNC.

Referring to FIG. 3, the 2 ms-TTI MAC frame includes a Header, a Payload, and an Optional. The Header includes DDIs and Ns of MAC-es PDUs for each individual SFN. The Payload includes data of MAC-es PDUs for each individual SFN. The Optional includes optional information.

‘N of HARQ Retr’ 320 and 340 corresponds to the N-RSN. Herein, a combination of Connection Frame Number (CFN) 300 and Sub-Frame Number (SFN) 310 and 330 is called a Time Stamp (TS). The TS represents the time when a Node B succeeds in decoding a MAC-e PDU and an SRNC can predict the time when a UE initially transmitted a new PDU, using the N-RSN and the TS. For example, in the case where there are 8 HARQ processes in a 2 ms TTI, if CFN (300)=36, SFN (310)=2 and N-RSN (320)=7, then the time at which the UE initially transmitted the MAC-e PDU can be calculated by:
Initial Tx Time=CFN*10 ms+SFN*2 ms−No. of HARQ process*TTI*N−RSN=36*10 ms+2*2 ms−8*2 ms*7=252 ms (1)

As described above, the SRNC predicts that the time at which the UE initially transmitted the MAC-e PDU is CFN=25 (262 ms/10 ms) and SFN (252 ms/10 ms)/2 ms)=1. The SRNC can reorder MAC-es PDUs transmitted from several Node Bs using the predicted values and Transmit Sequence Number (TSN) included in each MAC-es PDU, or using Outer Loop Power Control (OLPC).

For reference, the OLPC method adjusts power of a UE using a retransmission count (or the number of retransmissions) to meet a Signal-to-Interference Ratio (SIR) target which is a transmission error rate. The OLPC can be applied in such a manner that it increases the power of the UE for a high RSN, and decreases the power of the UE for a low RSN.

FIG. 4 is a diagram illustrating a EUDCH based on synchronous HARQ.

It is assumed in FIG. 4 that there are 4 HARQ processes and the numerals 1 to 4 in the boxes represent unique numbers of the HARQ processes. After a new MAC-e PDU 410 corresponding to each process was initially transmitted, transmission of the same PDUs 420 and 430 is repeated when the next same process is transmitted if a NACK signal is received for the process. Every time, an R-RSN transmitted over an E-DPCCH increases by one.

In the synchronous HARQ, the time interval in which the same process is transmitted is regular. Upon receiving an N-RSN, the SRNC can use the N-RSN value in the OLPC method or in the operation of reordering the MAC-es PDUs received from several Node Bs in one reordering buffer as described with reference to FIG. 3.

When the Node B is unable to calculate the correct RSN, the SRNC will not be aware of the situation of the Node B. Therefore, the SRNC may use the RSN in the OLPC or in the operation of reordering of the MAC-e PDUs with an incorrect retransmitted RSN, which causes a failure in the operation.

Accordingly, there is a need for an improved system and method for reporting a failure to calculate a correct retransmission count for a PDU to an SRNC.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method in which a Node B reports the situation to an SRNC when the Node B cannot calculate a correct retransmission count for a PDU.

According to one aspect of an exemplary embodiment of the present invention, a method is provided for transmitting packet data over an uplink channel in a mobile communication system in which retransmission of a packet is possible using a hybrid automatic retransmission request (HARQ) technique. A packet data unit (PDU) is received from a terminal by a base station and a determination is made as to whether the base station can calculate a retransmission number (RSN) indicating the number of retransmissions for the PDU. If the base station cannot calculate the RSN for the PDU, the RSN is set to a special value which serves as an indication that the number of retransmissions for the PDU is unknown and the set RSN is transmitted to a serving radio network controller (SRNC) along with the PDU.

According to another aspect of an exemplary embodiment of the present invention, a base station apparatus is provided for transmitting packet data over an uplink channel in a mobile communication system in which retransmission of a packet is possible using a hybrid automatic retransmission request (HARQ) technique. The apparatus comprises a receiver to receive a packet data unit (PDU) from a terminal; a retransmission number (RSN) error detector to determine whether the base station has successfully received an RSN indicating the number of retransmissions for the PDU, and setting the RSN to a special value indicating that the number of retransmissions for the PDU is unknown if the base station has failed to successfully receive the RSN for the PDU; and a transmitter to transmit the RSN set to the special value to a serving radio network controller (SRNC) along with the PDU.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will be more apparent from the following description taken in conjunction with the accompanying drawings in which:

FIG. 1A is a diagram illustrating a protocol structure of a general mobile communication system supporting EUDCH;

FIG. 1B is a diagram illustrating a structure of a MAC layer for a general UE and a format of one MAC-e PDU;

FIG. 2 is a diagram illustrating a MAC-e configuration and an HARQ operation of a general UE;

FIG. 3 is a diagram illustrating an exemplary 2 ms-TTI MAC frame transmitted from a Node B to an RNC;

FIG. 4 is a diagram illustrating a EUDCH based on synchronous HARQ;

FIG. 5 is a diagram illustrating possible problems occurring when an R-RSN is different from an N-RSN in the number of bits;

FIG. 6A is a diagram illustrating a procedure in which a Node B reports an inability to calculate an RSN for a successfully received MAC-e PDU to an SRNC according to an exemplary embodiment of the present invention;

FIG. 6B is a diagram illustrating a brief structure of an apparatus according to an exemplary embodiment of the present invention;

FIG. 7A is a flowchart illustrating an exemplary operation of a Node B according to an exemplary embodiment of the present invention;

FIG. 7B is a diagram illustrating an exemplary process of decoding a MAC-e PDU with an RSN according to an exemplary embodiment of the present invention;

FIG. 8A is a flowchart illustrating an exemplary process in which an SRNC uses the information in reordering packets according to an exemplary embodiment of the present invention;

FIG. 8B is a diagram illustrating an exemplary process in which an SRNC reorders packets according to the conventional method;

FIG. 8C is a diagram illustrating possible problems occurring during packet reordering of an SRNC according to the conventional method; and

FIG. 9 is a flowchart illustrating an exemplary process in which an SRNC receives information indicating that a RSN is unknown and uses the information in an OLPC operation according to another exemplary embodiment of the present invention.

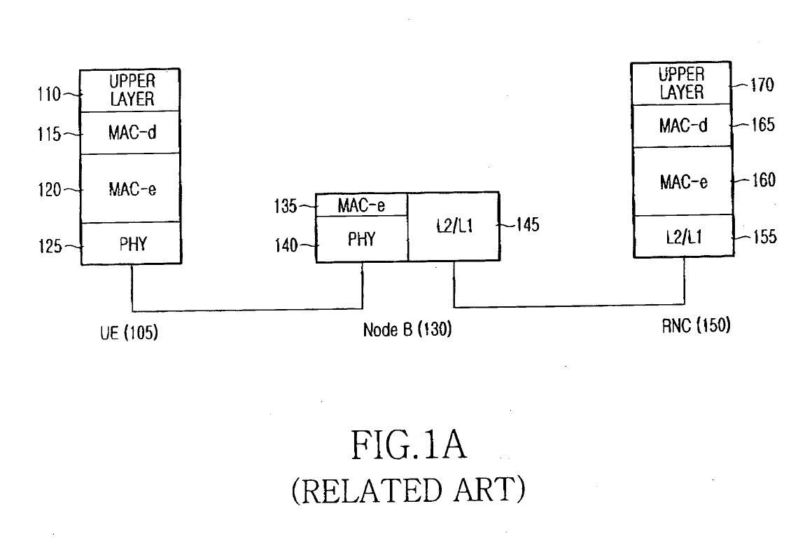

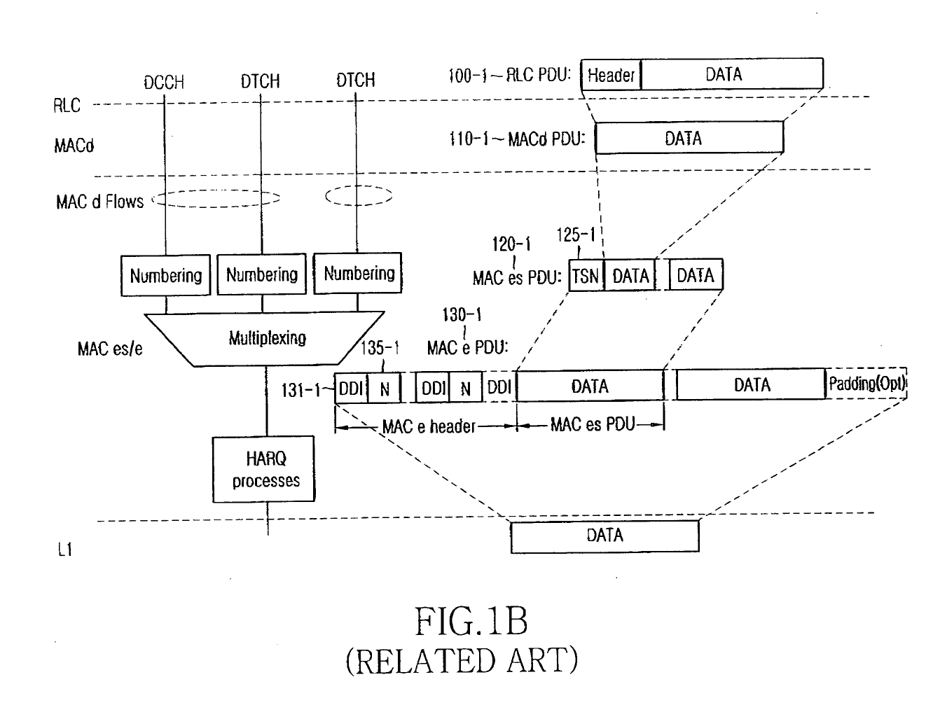

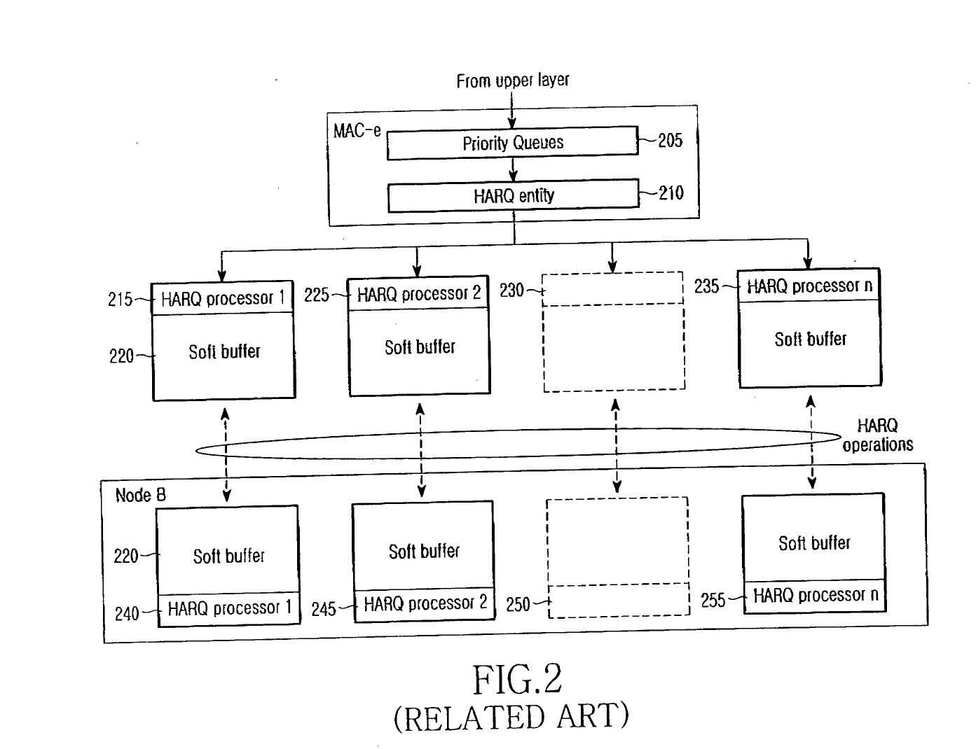

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

FIG. 5 is a diagram illustrating possible problems occurring when an R-RSN is different from an N-RSN in the number of bits.

Referring to FIG. 5, numerals in the boxes represent consecutive RSN values corresponding to the same process. A Node B receives an R-RSN value 510 from a UE. In this case, if the Node B receives an R-RSN 515 whose value is set to 3 (hereinafter referred to as “R-RSN=3”) after failure to receive at least three R-RSNs 511 due to reception failure of an E-DPCCH, the following two interpretations 520 and 540 are possible.

In a first interpretation 520, the Node B sets the reception failed R-RSN values 511 to consecutive values 2, 3 and 3 of the previous R-RSN, shown by reference numeral 521, determining that the previous data was continuously retransmitted. Based on this interpretation, the Node B sets an N-RSN 535 to 5 and transmits it to an SNRC with a successfully received MAC-e PDU, considering that the N-RSN values are set to 2, 3 and 4, as shown by reference numeral 531.

In a second interpretation 540, new data 0, 1 and 2, shown by reference numeral 541, is considered to be transmitted in the reception failed R-RSN interval. In this case, the Node B sets an N-RSN 555 to 3 and transmits it to the SRNC along with the successfully received MAC-e PDU, considering that the N-RSN values are set to 0, 1 and 2, as shown by reference numeral 551.

A failure in the operation may occur in the reordering or OLPC operation of the SNRC when the Node B transmits an erroneous N-RSN to the SRNC as it takes the second interpretation. This failure in the operation may still occur even though the first interpretation is correct and vice versa.

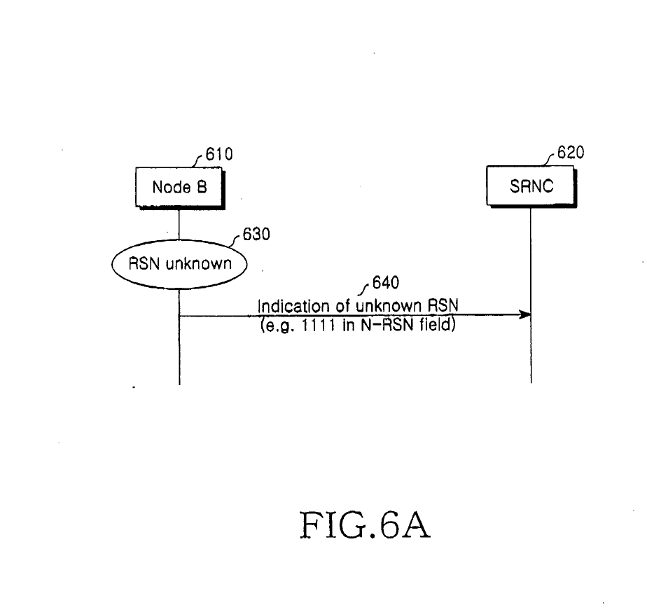

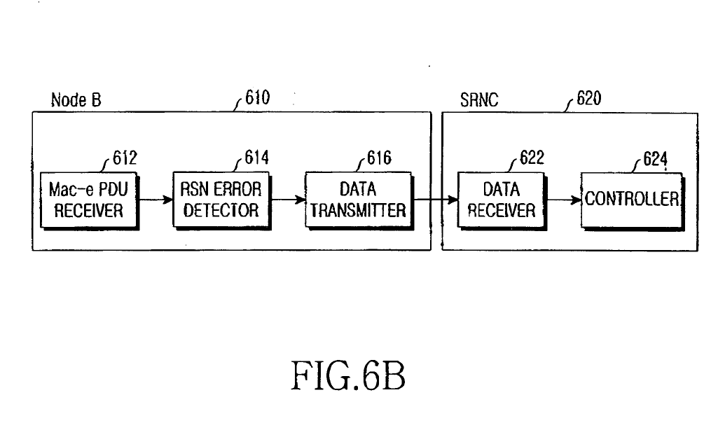

FIG. 6A is a diagram illustrating a procedure in which a Node B reports the inability to calculate an RSN for a successfully received MAC-e PDU to an SRNC according to an exemplary embodiment of the present invention.

Referring to FIG. 6A, if a Node B 610 cannot calculate an RSN for a successfully received MAC-e PDU in step 630, the Node B 610 reports to an SNRC 620 the situation where the RSN for the received MAC-e PDU is unknown, in step 640.

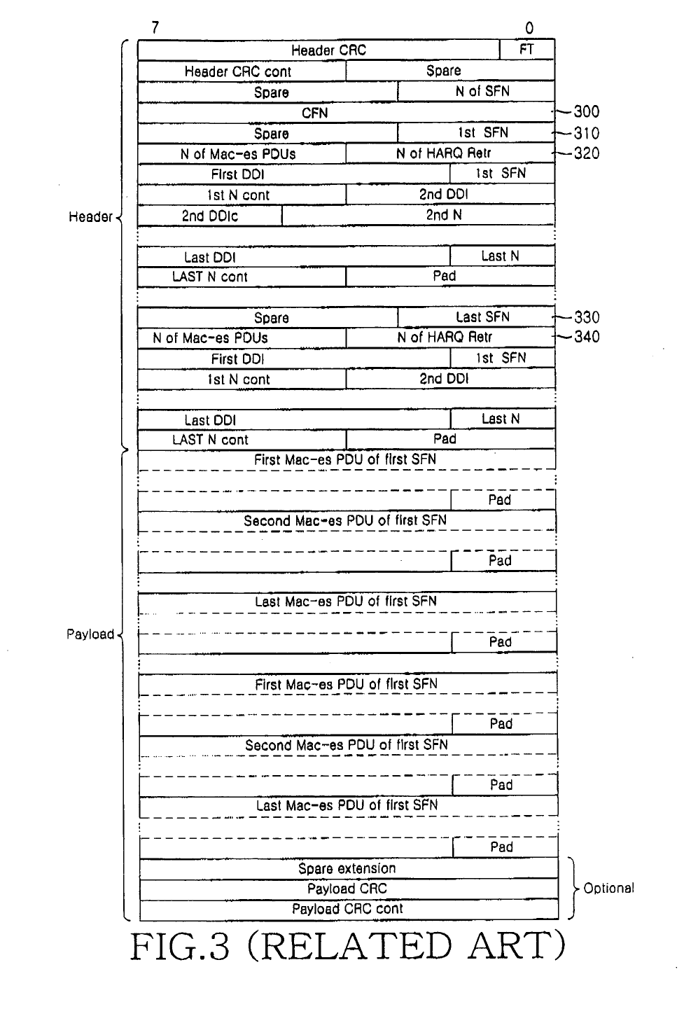

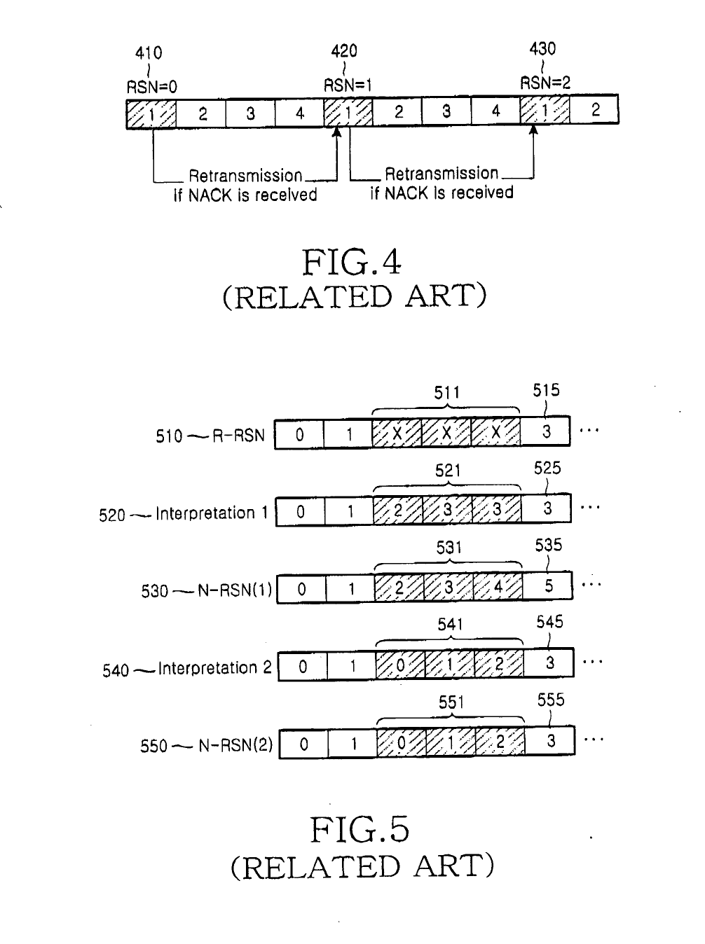

In this case, the Node B 610 can set a 4-bit N-RSN (‘N of HARQ Retr’ in FIG. 3) of the MAC-e PDU of FIG. 3 to a special value (for example, a binary number of ‘1111’) before transmission to the SRNC 620. Certain bits of the 4 bits set in the 4-bit N-RSN can be used for indicating that the RSN for the corresponding MAC-e PDU is unknown, and the other bits can be used for indicating a retransmission count for the corresponding MAC-e PDU.

For example, if the maximum possible number of retransmissions is limited to 7 for a UE, the total number of transmissions including the initial transmission is 8. In this case, 3 LSB bits of the 4 bits of the N-RSN can be used for setting the retransmission count and 1 MSB bit can be used for indicating the situation where the Node B 610 cannot calculate the RSN for the received MAC-e PDU. Therefore, when the N-RSN is larger than or equal to a binary number of ‘1000’, the N-RSN can be treated as the above-stated special value.

FIG. 6B is a diagram illustrating a structure of an apparatus according to an exemplary embodiment of the present invention.

The apparatus of FIG. 6B includes a Node B 610 with a MAC-e PDU receiver 612, an RSN error detector 614, a data transmitter 616, and an SRNC 620 having a data receiver 622 and a controller 624.

First, a structure of the Node B 610 will be described.

The MAC-e PDU receiver 612 receives a MAC-e PDU with an RSN from a UE.

The RSN error detector 614 acquires an RSN from a header of the received MAC-e PDU and determines whether there is any error in the acquired RSN. If there is any error in the acquired RSN, the RSN error detector 614 sets an N-RSN of the MAC-e PDU to a special value and transmits the MAC-e PDU to the data transmitter 616.

In a typical error situation, the RSN error detector 614 determines that there is an error in the RSN when it receives an RSN=3 after errors were detected from, for example, three or more consecutive RSNs. However, there are several available error situations in addition to the foregoing error situation.

For example, another error situation includes a handover situation in which the Node B initially receives a MAC-e PDU from a UE, an RSN of which is set to 3 (RSN=3).

The data transmitter 616 receives an RSN that is set to the special value from the RSN error detector 614 and transmits the received RSN to the SRNC 620 along with the MAC-e PDU.

Next, a structure of the SRNC 620 will be described.

The data receiver 622 receives a MAC-e PDU with an N-RSN from the Node B 610.

The controller 624 acquires the N-RSN from the MAC-e PDU received at the data receiver 622, and determines whether the N-RSN is set to a special value. If it is determined that the N-RSN is set to a special value, the controller 624 controls an operation of the SRNC 620 so that it performs a reordering operation or an OLPC operation on the MAC-e PDU using only the Transmit Sequence Number (TSN) value of the MAC-e PDU, disregarding the N-RSN.

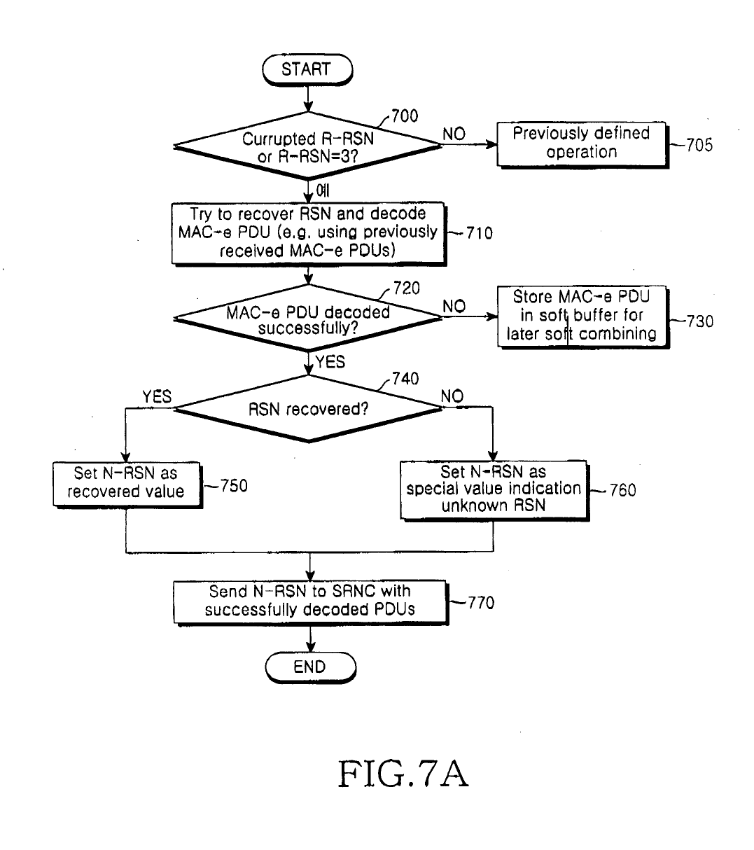

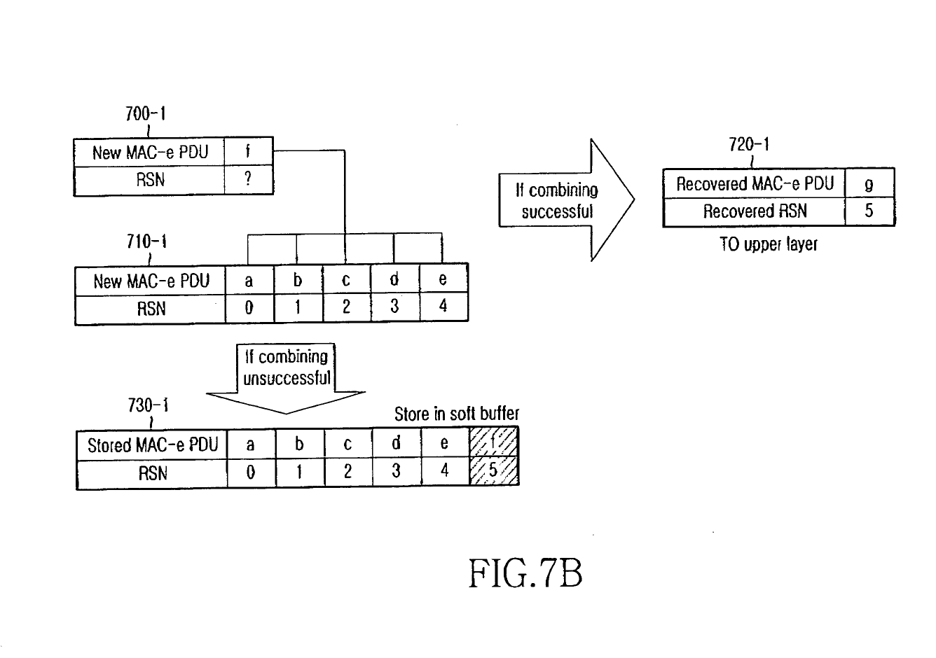

FIG. 7A is a flowchart illustrating an exemplary operation of a Node B according to exemplary embodiment of the present invention.

Referring to FIG. 7A, a Node B determines in step 700 whether it has received an E-DPCCH with an R-RSN=3 or whether it has successfully received an R-RSN. If the Node B succeeded in the reception, it performs the existing operation in step 705. However, if the Node B failed in the reception, it proceeds to step 710.

In step 710, the Node B attempts to soft-combine the data received from the current E-DPDCH with the data previously stored in a soft buffer to recover the correct RSN and decode MAC-e PDU. The Node B determines in step 720 whether it has successfully decoded the MAC-e PDU.

If the Node B has failed in decoding, it stores the currently received data in the soft buffer in step 730. However, if the Node B has successfully decoded the MAC-e PDU, the Node B further determines in step 740 whether it has successfully recovered the RSN.

If the Node B has successfully recovered the RSN, it sets an N-RSN included in a MAC-es PDU of FIG. 3 to the recovered RSN in step 750, and transmits the MAC-es PDU to an SRNC in step 770.

However, if it is determined in step 740 that the Node B has failed to successfully recover the RSN, the Node B proceeds to step 760. In step 760, the Node B sets an N-RSN to a special value (for example, a binary number of ‘1111’) when it has successfully received the MAC-e PDU even though it has failed to successfully recover the RSN. Thereafter, in step 770, the Node B transmits to the SRNC a MAC-es PDU with the N-RSN set to the special value.

Certain bits among the 4 bits set in the 4-bit N-RSN can be used for indicating the situation where the Node B cannot calculate an RSN of the corresponding MAC-e PDU, and the other bits can be used for indicating a retransmissions count for the corresponding MAC-e PDU.

If the maximum possible retransmission count is limited to 7 for a UE, 3 LSB bits among the 4 bits set in the N-RSN can be used for setting the retransmission count and 1 MSB bit can be used for indicating the situation where the Node B cannot calculate the RSN of the received MAC-e PDU. For example, the Node B sets the 1 MSB bit of the N-RSN to ‘1’, as the information indicating that the RSN of the received MAC-e PDU is unknown, and transmits the resultant N-RSN to the SRNC.

Upon receiving the information indicating that the Node B cannot calculate the correct RSN, the SRNC can use the information in performing a reordering or OLPC operation on the packets.

FIG. 7B is a diagram illustrating an exemplary process of decoding a MAC-e PDU with an RSN according to an exemplary embodiment of the present invention.

Referring to FIG. 7B, a soft buffer of a Node B has previously stored therein incomplete data ‘a’ to ‘e’ received at a previous time corresponding to an HARQ process #n (see 710-1), and stored RSN values ‘0’ to ‘4’ corresponding to the data ‘a’ to ‘e’, respectively.

When incomplete data ‘f’, an RSN which is unknown, is received at a new time corresponding to the HARQ process #n (see 700-1), the Node B soft-combines the existing data ‘a’ to ‘e’ stored in the soft buffer with the data ‘f’. If the Node B has failed in the soft combining, it sets the RSN to a number which is larger by one than the last RSN of the soft buffer, and stores the resultant value in the soft buffer as shown by reference numeral 730-1. This process corresponds to step 730 of FIG. 7A.

Alternatively, if the Node B has succeeded in the soft combining, it sets the RSN to a number which is larger by one than the last RSN in the existing soft buffer before recovering, and conveys the soft-combined data ‘g’ to an upper layer, as shown by reference numeral 720-1. This process corresponds to step 750 of FIG. 7A.

As described above, in FIG. 7B, the Node B can recover the RSN regardless of the success in the soft combining. However, if the Node B cannot calculate the last RSN of the soft buffer, it cannot recover an RSN of new data. In this case, the Node B should proceed to step 760 of FIG. 7A.

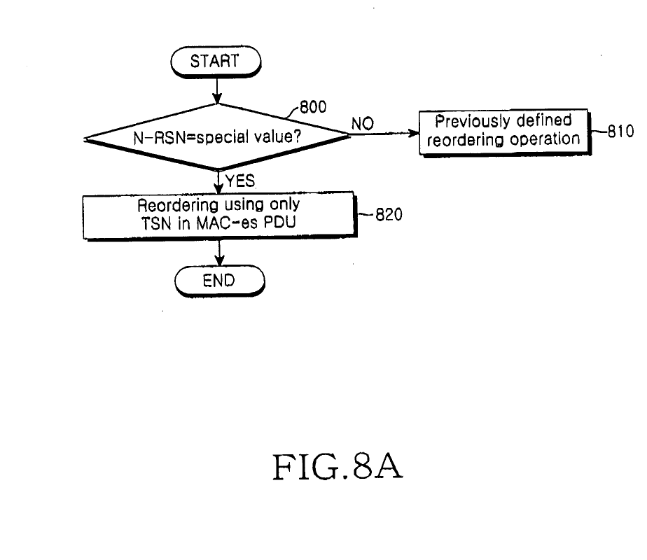

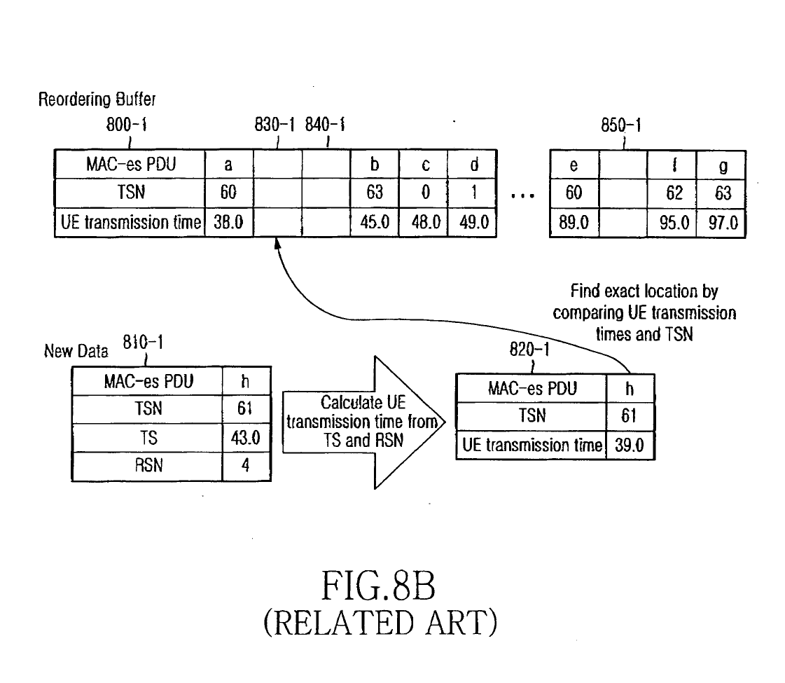

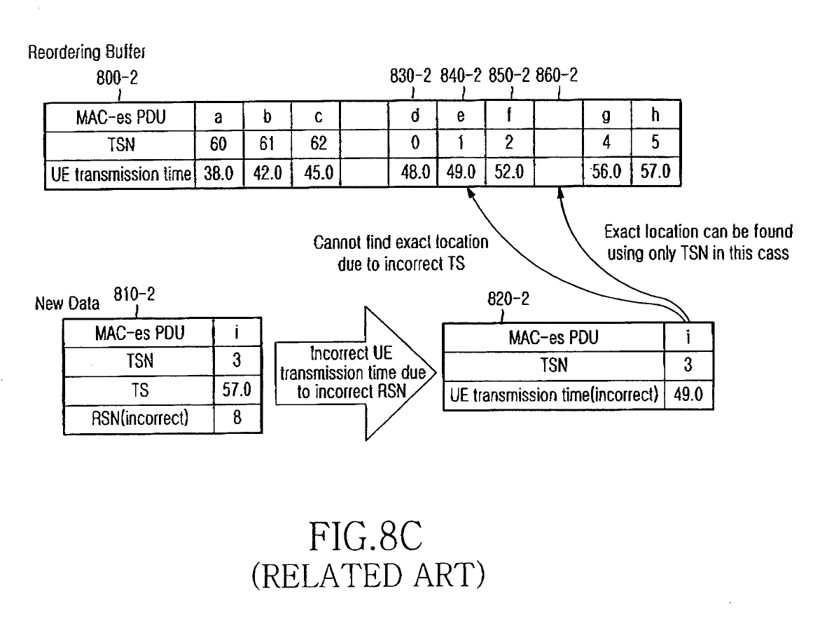

FIG. 8A is a flowchart illustrating an exemplary process in which an SRNC uses the information in reordering packets according to an exemplary embodiment of the present invention.

In step 800 of FIG. 8A, an SRNC determines whether it has received an N-RSN with a special value (for example, a binary number of ‘1111’ or a binary number with a MSB bit of ‘1’). If the SRNC has received the N-RSN with the special value, it performs a reordering operation using only the TSN value in step 820, disregarding the RSN.

However, if the SRNC has failed to receive the N-RSN with the special value, the SRNC proceeds to step 810. In step 810, the SRNC determines the time at which a UE performed initial transmission using an RSN and a TS value in the conventional method as shown in Equation (1), and then detects a correct position where a new PDU will be located in a reordering buffer using the TSN value.

For reordering, the conventional method uses the time when the UE performed initial transmission using the RSN and the TS instead of the TSN. This particular time is used to prepare for cases when the SRNC is unaware of the position into which it should insert new data if the TSN has 6 bits and the size of the reordering buffer is more than 64 bits.

FIG. 8B is a diagram illustrating an exemplary process in which an SRNC reorders packets according to the conventional method.

Referring to FIG. 8B, an SRNC receives new data 810-1 in a state 800-1 of the current reordering buffer. In this case, if only the TSN is used, the parts corresponding to a TSN=61 among the empty parts 830-1, 840-1 and 850-1 of the reordering buffer will include the two parts 830-1 and 850-1, so the SRNC cannot determine the position in which it should insert the new data.

Alternatively, if the SRNC determines the time (UE transmission time) when the UE performed initial transmission using the TS and the RSN in accordance with Equation (1) (see 820-1), it compares the determined time with a UE transmission time for the data stored in the reordering buffer and determines the position in which it should store the new data in the reordering buffer.

The UE transmission time determined using the TS and the RSN is ‘39.0’ (see 820-1) when the number of the HARQ processes is 5. Therefore, the SNRC determines that the part 830-1 is the correct position. This determination is made by comparing the TSN after knowing that the found UE transmission time 820-1 should be stored in the part indicated by reference numerals 830-1 or reference numeral 840-1.

When the reordering is performed using the conventional method shown in FIG. 8B, a Node B that cannot calculate a correct RSN value has no way to report the fact to the SRNC. Therefore, if the Node B sets the RSN to an arbitrary value and transmits the resultant RSN to the SRNC, the SRNC estimates an initial UE transmission time using the RSN value that is set to the arbitrary value, causing a possible error in reordering.

FIG. 8C is a diagram illustrating possible problems occurring during packet reordering of an SRNC according to the conventional method.

Referring to FIG. 8C, if a Node B fails to recover a correct RSN value of 4 for new data 810-2 received from a UE in a state 800-2 of the current reordering buffer and transmits an incorrect RSN=8 to an SRNC, the SRNC calculates a wrong UE transmission time from Equation (1).

That is, if the SRNC calculates the UE transmission time as 49.0 as shown by reference numeral 820-2 and uses the UE transmission time in a reordering operation, the SRNC will attempt to insert the data 820-2 between the parts indicated by reference numerals 830-2 and 850-2. However, because data 840-2 already exists between the parts indicated by reference numerals 830-2 and 850-2 and there is an incorrect TSN during comparison of the TSN, an error occurs in the reordering operation.

However, when the Node B reports to the SRNC the fact that an RSN of the corresponding data is the incorrect RSN as shown in FIG. 8A, the SRNC performs the reordering using only the TSN value the incorrect RSN value will be disregarded. As a result, the SRNC can perform correct reordering by inserting the data 820-2 in the empty part indicated by reference numeral 860-2.

As described above, in the case where the reordering is performed using the conventional method as shown in FIGS. 8B and 8C, if the SRNC has no information indicating incorrectness of the RSN value, the SRNC estimates an initial UE transmission time using an N-RSN value set to an arbitrary value, causing a possible error in the reordering. However, the SRNC can reduce a reordering error rate by performing the reordering using only the TSN value regardless of the incorrect RSN value as described with reference to FIG. 8A.

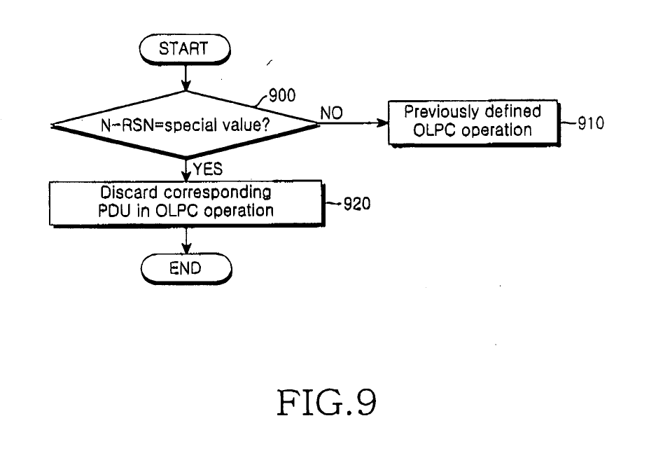

FIG. 9 is a flowchart illustrating an exemplary process in which an SRNC uses received information. Upon receiving the information indicating that a correct RSN is unknown, an SRNC uses the information in an OLPC operation according to another exemplary embodiment of the present invention.

Referring to FIG. 9, an SRNC determines in step 900 whether an N-RSN has a special value. If the N-RSN does not have a special value, the SRNC performs in step 910 the previously defined OLPC operation using a MAC-es PDU including the MAC-es PDU with the N-RSN that does not have the special value.

However, if the N-RSN has a special value, the SRNC performs in step 920 an OLPC operation using a MAC-es PDU excluding the MAC-es PDU with the N-RSN that does have the special value.

Although exemplary embodiments of the present invention have been described with reference to the MAC-e PDU transmitted by the UE in the case where the EUDCH is used in the WCDMA system, the present invention is not limited to this, and can be applied to any mobile communication system in which a base station (or Node B) receives a PDU from a terminal (or UE) and transmits the PDU to an SRNC.

When the Node B cannot calculate an HARQ retransmission count for a EUDCH, it transmits to the SRNC the information indicating that the retransmission count is unknown. In this case, if the Node B inserts an arbitrary value in a retransmission count field, the SRNC can prevent a failure in the operation from occurring in the reordering or OLPC operation.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for transmitting packet data over an uplink channel in a mobile communication system in which retransmission of a packet is possible using a hybrid automatic retransmission request (HARQ) technique, the method comprising:
receiving, by a base station, a packet data unit (PDU) from a terminal and determining whether the base station can calculate a retransmission number (RSN) indicating the number of retransmissions for the PDU;
setting the RSN to a special value indicating that the number of retransmissions for the PDU is unknown, if the base station cannot calculate the RSN for the PDU; and
transmitting the set RSN to a serving radio network controller (SRNC) along with the PDU.

2. The method of claim 1, wherein the setting of the RSN to a special value further comprises the setting of the RSN of 4 bits to a binary number of ‘1111’.

3. The method of claim 1, wherein the setting of the RSN to a special value comprises the setting of bits among bits of the RSN to a value indicating that the RSN for the PDU is unknown, and setting the other bits to a value indicating the number of retransmissions for the PDU.

4. The method of claim 2, wherein the setting of the RSN to a special value comprises the setting of 1 most significant bit (MSB) among the 4 bits of the RSN to a value indicating that the RSN for the PDU is unknown, and setting 3 least significant bits (LSB) to a value indicating the number of retransmissions for the PDU.

5. The method of claim 1, wherein the determining comprises the determining that the base station cannot calculate the RSN for the PDU when the RSN of the PDU is set to a maximum value.

6. The method of claim 1, where the determining comprises:
decoding the PDU;
determining whether an RSN for the decoded PDU has been successfully recovered; and
determining that the base station cannot calculate the RSN, when the RSN has not been successfully recovered.

7. The method of claim 1, further comprising:
receiving, by the SRNC, the PDU with the RSN set to the special value from the base station; and
performing, by the SRNC, a reordering operation on the PDU using only the transmit sequence number (TSN) for the PDU, disregarding the RSN set to the special value.

8. The method of claim 1, further comprising:
receiving, by the SRNC, the PDU with the RSN set to the special value from the base station; and
performing, by the SRNC, an outer loop power control (OLPC) operation using the data received from the base station except for the received PDU with the RSN set to the special value.

9. A base station apparatus for transmitting packet data over an uplink channel in a mobile communication system in which retransmission of a packet is possible using a hybrid automatic retransmission request (HARQ) technique, the apparatus comprising:
a receiver for receiving a packet data unit (PDU) from a terminal;
a retransmission number (RSN) error detector for determining whether the base station has successfully received an RSN indicating the number of retransmissions for the PDU, and setting the RSN to a special value indicating that the number of retransmissions for the PDU is unknown when the base station has failed to successfully receive the RSN for the PDU; and
a transmitter for transmitting the RSN set to the special value to a serving radio network controller (SRNC) along with the PDU.

10. The base station apparatus of claim 9, wherein the RSN error detector determines that the base station has failed to successfully receive the RSN for the PDU when the RSN of the PDU is set to a maximum value.

11. The base station apparatus of claim 9, wherein the RSN error detector decodes the PDU received from the terminal, determines whether the RSN for the decoded PDU has been correctly recovered, and determines that the base station has failed to successfully receive the RSN when the RSN has not been correctly recovered.

12. The base station apparatus of claim 9, wherein the RSN error detector sets the RSN of 4 bits to a binary number of ‘1111’.

13. The base station apparatus of claim 9, wherein the RSN has a number of bits, and the RSN error detector sets bits among the bits of the RSN to a value indicating that the number of retransmissions for the PDU is unknown, and sets the other bits to a value indicating the number of retransmissions for the PDU.

14. The base station apparatus of claim 12, wherein the RSN error detector sets 1 most significant bit (MSB) among the 4 bits of the RSN to a value indicating that the number of retransmissions for the PDU is unknown, and sets 3 least significant bits (LSB) to a value indicating the number of retransmissions for the PDU.
